(19) United States
(12) Patent Application Publication
(10) Pub. No.: US 2012/0105491 A1
(43) Pub. Date: May 3, 2012

(54) STRUCTURE FOR ADJUSTING BACKLIGHT bRIGHTNESS OF ELECTRONIC APPARATUS

(75) Inventors: Fu-Hsing HOU, Toufen Township (TW); Wei-Chen Liang, Baoshan Township (TW); Wen-Cen Li, Hsinchu City (TW)

(73) Assignee: Integrated Crystal Technology Inc.

(21) Appl. No.: 12/938,935

(22) Filed: Nov. 3, 2010

(51) Int. Cl. G09G 5/10

(52) U.S. Cl. 345/690

(57) ABSTRACT

A structure for adjusting backlight brightness of an electronic apparatus includes an indicator cover with an optical window and a light detecting circuit board. The indicator cover with an optical window has a window disposed thereon. The light detecting circuit board is installed in the indicator cover with an optical window and disposed correspondingly to the window. In addition, the light detecting circuit board is electrically connected to the backlight module of the electronic apparatus and has a light detecting circuit disposed thereon. The light detecting circuit has a control unit, a light emitting unit, a driving unit, and a storage unit. The light emitting unit has a light emitting component inside the indicator cover and an ambient light detecting unit. Therefore, the control unit controls the light emitting component inside the indicator cover flickering, and a detecting signal is transmitted to the control unit and then compared to the stored parameter, thus adjusting backlight brightness according to the stored parameter by the control unit when the light emitting component inside the indicator cover is not lighted and then the ambient light detecting unit receives external ambient light through the window.

### BACKGROUND OF THE INVENTION

1. Field of the Invention

The present invention relates to a display screen, and more particularly to a structure for adjusting backlight brightness of an electronic apparatus.

2. Description of Prior Art

Liquid crystal display screens are widely used in various electronic apparatuses such as LCDs, mobile phones, PDAs, GPSs, ipods, ipads, iphones, and digital cameras.

Nowadays, these liquid crystal display screens are be classified into two major categories: reflective display screens and transmissive display screens. Because the electricity consumption of the reflective display screens is extremely larger than that of the transmissive display screens, the above-mentioned electronic apparatuses are mostly the transmissive display screens, thus conforming with the demands of saving energy and saving money.

In general, the displayed images would be washed out because of the high outdoor light, this results in reducing contrast ratio. Therefore, users can not clearly see frames of the display screens when using the transmissive display screens. Accordingly, it is not convenient that the display screens have to be used in a low-light environment so that users can clearly see frames of the display screens.

However, the light of the transmissive display screens is too bright to users when the display screens are used in a low-light environment. Thus, this will cause human eye discomfort and larger power consumption for long time using.

In order to solve the above-mentioned problems, the cover of the electronic apparatus is usually opened to form a through hole. In addition, a light sensor is installed in the through hole to detect the external ambient light, thus adjusting backlight brightness of the electronic apparatus.

### SUMMARY OF THE INVENTION

The major objective of the present invention is that a light emitting component inside the indicator cover of the light emitting diode, which is used as an indicator lamp, and an ambient light detecting unit, which is used for detecting light, are integrated into a single element. The single element can be directly disposed in the original through hole, which in the indicator lamp disposed, of an indicator cover with an optical window of the electronic apparatus. Thus, the ambient light detecting unit can detect external ambient light without further opening another through hole on the indicator cover with an optical window to install the ambient light detecting unit.

In order to achieve the above-mentioned objectives, a structure for adjusting backlight brightness of an electronic apparatus is disclosed. The structure is installed in an indicator cover with an optical window and electrically connected to a backlight module. The structure includes an indicator cover with an optical window and a light detecting circuit board. The indicator cover with an optical window has a window disposed thereon. The light detecting circuit board is installed in the indicator cover with an optical window and disposed correspondingly to the window. In addition, the light detecting circuit board is electrically connected to the backlight module and has a light detecting circuit disposed thereon.

The light detecting circuit has a control unit, a driving unit, a light emitting unit, and a storage unit. The control unit is used to control the light detecting circuit. The driving unit is electrically connected to the control unit to receive a driving signal outputted from the control unit. The light emitting unit has a light emitting component inside the indicator cover and an ambient light detecting unit. The light emitting component inside the indicator cover and the ambient light detecting unit are packaged by a package body, and the light emitting component inside the indicator cover is electrically connected to the driving unit. The storage unit is electrically connected to the control unit to store a parameter of adjusting brightness;

wherein the control unit controls the light emitting component inside the indicator cover flickering, and a detecting signal is transmitted to the control unit and then compared to the stored parameter, thus adjusting backlight brightness according to the stored parameter by the control unit when the light emitting component inside the indicator cover is not lighted and then the ambient light detecting unit receives external ambient light through the window.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic block diagram of a light detecting circuit according to the present invention;

FIG. 2 is a schematic view of using the light detecting circuit;

FIG. 3 is another schematic view of using the light detecting circuit;

FIG. 4 is further another schematic view of using the light detecting circuit;

FIG. 5 is further another schematic view of using the light detecting circuit; and

FIG. 6 is another schematic block diagram of the light detecting circuit.

### DETAILED DESCRIPTION OF THE INVENTION

Reference will now be made to the drawing figures to describe the present invention in detail.

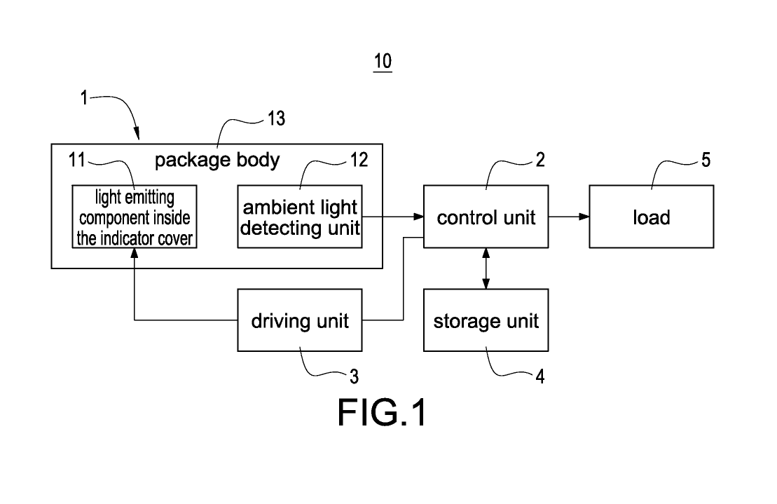

Reference is made to FIG. 1 which is a schematic block diagram of a light detecting circuit according to the present invention. The light detecting circuit 10 includes a light emitting unit 1, a control unit 2, a driving unit 3, and a storage unit 4.

The light emitting unit 1 is composed of a light emitting component inside the indicator cover 11 and an ambient light detecting unit 12, and the light emitting component inside the indicator cover 11 and the ambient light detecting unit 12 are packaged by a transparent package body 13. The light emitting component inside the indicator cover 11 is an LED chip. The control unit 2 controls the light emitting component inside the indicator cover 11 flickering (bright and dark) by a driving signal through the driving unit 3. In addition, the ambient light detecting unit 12 receives external ambient light when the light emitting component inside the indicator cover 11 is not lighted.

The control unit 2 is electrically connected to the light emitting unit 1 to calculate a signal outputted from the ambient light detecting unit 12. Afterward, the calculated signal is compared to a parameter stored in the storage unit 4, thus outputting a control signal to control a load 5. In this embodiment, the control unit 2 can be a microprocessor (MP) or a central processing unit (CPU).

The driving unit 3 is electrically connected to the control unit 2 to receive a signal outputted from the control unit 2, thus driving the light emitting chip 11 flickering.

The storage unit 4 is electrically connected to the control unit 2 to store the parameter of adjusting backlight brightness of the electronic apparatus. In this embodiment, the storage unit 4 is a memory.

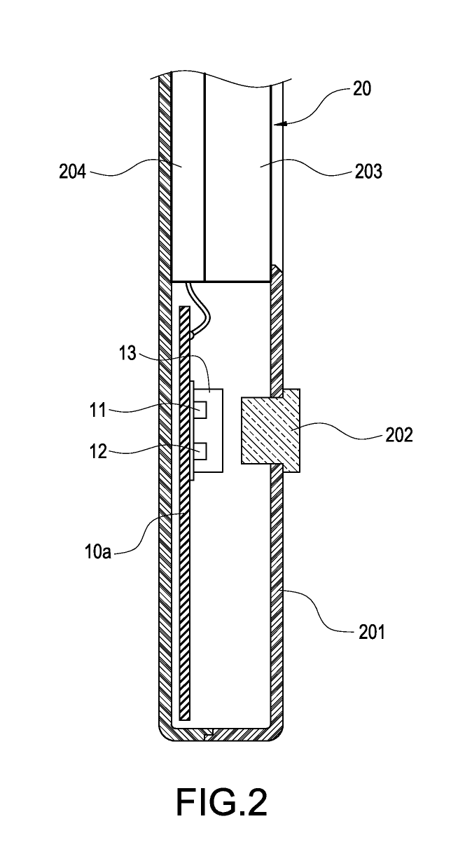

Reference is made to FIG. 1 and further made to FIG. 2 which is a schematic view of using the light detecting circuit. As shown in FIG. 2, the light detecting circuit 10 is a single light detecting circuit board 10a or is directly installed on a main circuit board of the electronic apparatus 20 when the light emitting unit 1 is used as an indicator lamp. The light detecting circuit 10 is installed in a predetermined position an indicator cover with an optical window 201 of an electronic apparatus 20. If the indicator cover with an optical window 201 is not transparent, the indicator cover with an optical window 201 has a window 202 disposed thereon. The window 202 is a light conducting element, and the light detecting circuit board 10a is electrically connected to a backlight module 204 on a fluorescent screen 203 of the electronic apparatus 20.

During using the electronic apparatus 20, the control unit 2 controls the light emitting component inside the indicator cover 11 flickering (by the driving signal through the driving unit 3). The ambient light detecting unit 12 receives external ambient light through the window 202 when the light emitting component inside the indicator cover 11 is not lighted. Afterward, the received (light) signal is transmitted to the control unit 2 to be processed. Afterward, the processed signal is compared to the stored parameter in the storage unit 4, thus adjusting backlight brightness of the backlight module 204 according to the stored parameter by the control unit 2. Therefore, users can clearly see frames of the fluorescent screen 203 of the electronic apparatus 20, when the external ambient light is too bright or too dark.

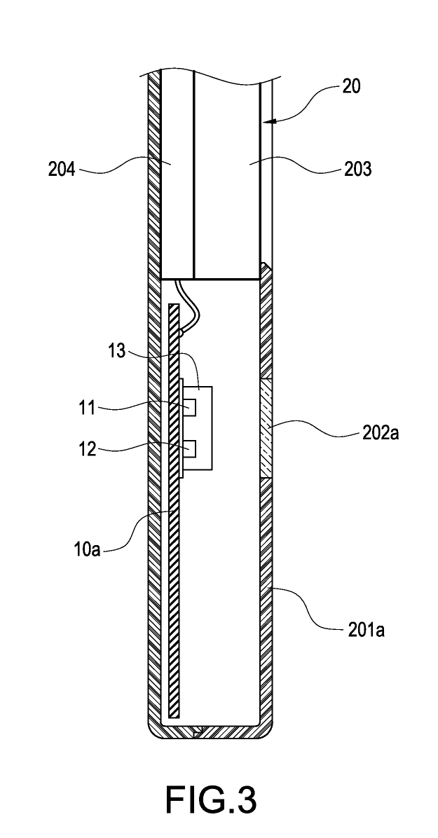

Reference is made to FIG. 1 and further made to FIG. 3 which is another schematic view of using the light detecting circuit. The using state in FIG. 3 is nearly the same to that in FIG. 2. The major difference is that the position of the indicator cover with an optical window 201a, correspondingly to the light emitting unit 1, can be regarded as a window 202a when the indicator cover with an optical window 201a of the electronic apparatus 20 is transparent. The control unit 2 controls the light emitting component inside the indicator cover 11 flickering (by the driving signal through the driving unit 3). The ambient light detecting unit 12 directly receives external ambient light through the window 202a, when the light emitting component inside the indicator cover 11 is not lighted. Afterward, the received (light) signal is transmitted to the control unit 2 to be processed, thus adjusting backlight brightness of the backlight module 204 according to the stored parameter by the control unit 2. Therefore, users can clearly see frames of the fluorescent screen 203 of the electronic apparatus 20, when the external ambient light is too bright or too dark.

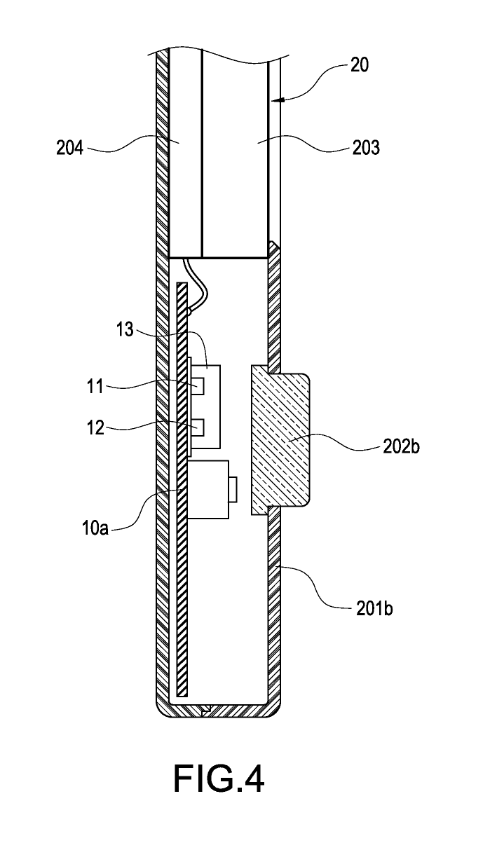

Reference is made to FIG. 1 and further made to FIG. 4 which is further another schematic view of using the light detecting circuit. A light transmissive key 202b, which is disposed on the indicator cover with an optical window 201b, is a light guiding element. During using the electronic apparatus 20, the control unit 2 controls the light emitting component inside the indicator cover 11 flickering (by the driving signal through the driving unit 3). The ambient light detecting unit 12 receives external ambient light guided from the light transmissive key 202b when the light emitting component inside the indicator cover 11 is not lighted. Afterward, the received (light) signal is transmitted to the control unit 2 of the light detecting circuit board 10a to be processed, thus adjusting backlight brightness of the backlight module 204 according to the stored parameter by the control unit 2. Therefore, users can clearly see frames of the fluorescent screen 203 of the electronic apparatus 20, when the external ambient light is too bright or too dark.

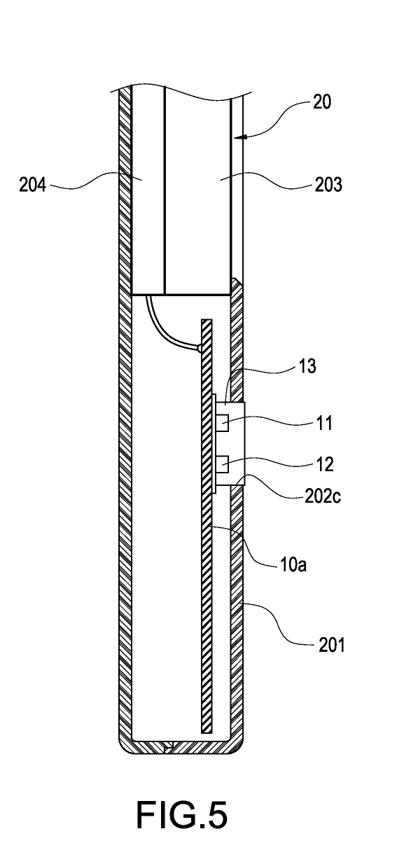

Reference is made to FIG. 1 and further made to FIG. 5 which is further another schematic view of using the light detecting circuit. If a window 202c disposed on an indicator cover with an optical window 201c is a through hole, the light emitting unit 1 can be installed into the through hole. During using the electronic apparatus 20, the control unit 2 controls the light emitting component inside the indicator cover 11 flickering (by the driving signal through the driving unit 3). The ambient light detecting unit 12 directly receives external ambient light when the light emitting component inside the indicator cover 11 is not lighted. Afterward, the received (light) signal is transmitted to the control unit 2 of the light detecting circuit board 10a to be processed, thus adjusting backlight brightness of the backlight module 204 according to the stored parameter by the control unit 2. Therefore, users can clearly see frames of the fluorescent screen 203 of the electronic apparatus 20, when the external ambient light is too bright or too dark.

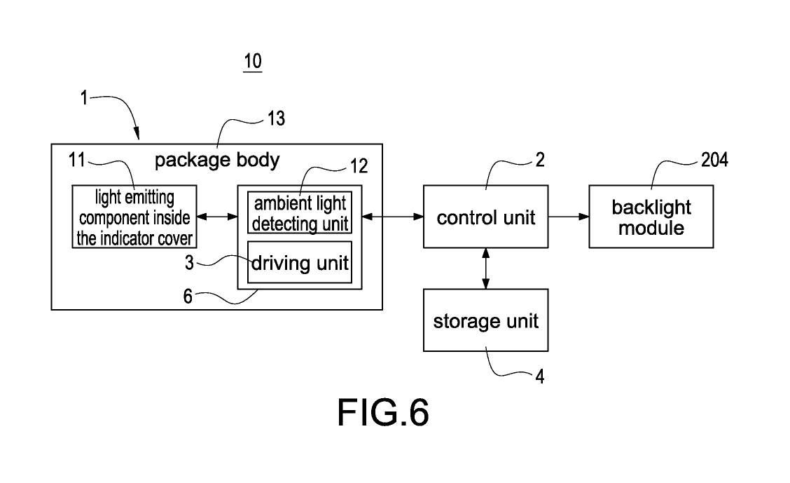

Reference is made to FIG. 6 which is another schematic block diagram of the light detecting circuit. The major difference between the embodiment in FIG. 6 and that in FIG. 1 is that an ambient light detecting unit 12 and a driving unit 3 of the light emitting unit 1 are integrated into a light detecting driving unit 6. During using the electronic apparatus 20, the control unit 2 controls the light emitting component inside the indicator cover 11 flickering (by the driving signal through the driving unit 3). The ambient light detecting unit 12 receives external ambient light when the light emitting component inside the indicator cover 11 is not lighted. Afterward, the received (light) signal is transmitted to the control unit 2 to be processed. Afterward, the processed signal is compared to the stored parameter in the storage unit 4, thus adjusting backlight brightness of the backlight module 204 according to the stored parameter by the control unit 2. Therefore, users can clearly see frames of the fluorescent screen 203 of the electronic apparatus 20, when the external ambient light is too bright or too dark.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A structure for adjusting backlight brightness of an electronic apparatus, the structure installed in an indicator cover with an optical window and electrically connected to a backlight module, the structure comprising:
an indicator cover with an optical window having a window disposed thereon;
a light detecting circuit board installed in the indicator cover with an optical window and disposed correspondingly to the window, and electrically connected to the backlight module and having a light detecting circuit disposed thereon; the light detecting circuit comprising:
a control unit controlling the light detecting circuit;
a driving unit electrically connected to the control unit to receive a driving signal outputted from the control unit;
a light emitting unit having a light emitting component inside the indicator cover and an ambient light detecting unit, and the light emitting component inside the indicator cover electrically connected to the driving unit; and
a storage unit electrically connected to the control unit to store a parameter of adjusting brightness;
wherein the control unit is configured to control the light emitting component inside the indicator cover flickering, and a detecting signal is transmitted to the control unit and then compared to the stored parameter, thus adjusting backlight brightness according to the stored parameter by the control unit when the light emitting component inside the indicator cover is not lighted and then the ambient light detecting unit receives external ambient light through the window.

2. The structure for adjusting backlight brightness of the electronic apparatus in claim 1, wherein the indicator cover with an optical window is transparent or opaque.

3. The structure for adjusting backlight brightness of the electronic apparatus in claim 2, wherein the window is a light conducting element or a light transmissive key.

4. The structure for adjusting backlight brightness of the electronic apparatus in claim 1, wherein in the light emitting component inside the indicator cover is an LED chip.

5. The structure for adjusting backlight brightness of the electronic apparatus in claim 4, wherein the light emitting component inside the indicator cover and the ambient light detecting unit are packaged by a package body.

6. The structure for adjusting backlight brightness of the electronic apparatus in claim 1, wherein the control unit is a microprocessor (MP) or a central processing unit (CPU).

7. The structure for adjusting backlight brightness of the electronic apparatus in claim 1, wherein the storage unit is a memory.

8. A structure for adjusting backlight brightness of an electronic apparatus, the structure installed in a an indicator cover with an optical window and electrically connected to a backlight module, the structure comprising:
an indicator cover with an optical window having a window disposed thereon;
a light detecting circuit board installed in the indicator cover with an optical window and disposed correspondingly to the window, and electrically connected to the backlight module and having a light detecting circuit disposed thereon; the light detecting circuit comprising:
a control unit controlling the light detecting circuit;
a light emitting unit installed in the window and having a light emitting component inside the indicator cover and a light detecting driving unit, and the light emitting component inside the indicator cover electrically connected to a light detecting driving unit and the light detecting driving unit electrically connected to the control unit; and
a storage unit electrically connected to the control unit to store a parameter of adjusting brightness;
wherein the control unit is configured to control the light emitting component inside the indicator cover flickering through the light detecting driving unit, and a detecting signal is transmitted to the control unit and then compared to the stored parameter, thus adjusting backlight brightness according to the stored parameter by the control unit when the light emitting component inside the indicator cover is not lighted and then the light detecting driving unit receives external ambient light.

9. The structure for adjusting backlight brightness of the electronic apparatus in claim 8, wherein the light transmissive portion is a through hole.

10. The structure for adjusting backlight brightness of the electronic apparatus in claim 8, wherein the light emitting component inside the indicator cover is an LED chip.

11. The structure for adjusting backlight brightness of the electronic apparatus in claim 10, wherein the light emitting component inside the indicator cover and the light detecting driving unit are packaged by a package body.

12. The structure for adjusting backlight brightness of the electronic apparatus in claim 11, wherein the light detecting driving unit is composed of an ambient light detecting unit and a driving unit, and the ambient light detecting unit is electrically connected to the control unit and the driving unit and the light emitting component inside the indicator cover are electrically connected to the control unit.

13. The structure for adjusting backlight brightness of the electronic apparatus in claim 8, wherein the control unit is a microprocessor (MP) or a central processing unit (CPU).

14. The structure for adjusting backlight brightness of the electronic apparatus in claim 8, wherein the storage unit is a memory.
